(19) United States
(12) Patent Application Publication
(10) Pub. No.: US 2005/0227009 A1
(43) Pub. Date: Oct. 13, 2005

(54) Epoxy spray lining for liquid-cooled generator stator bar clips

(76) Inventors: Yu Wang, Clifton Park, NY (US); Waheed Tony Mall, Waterford, NY (US); Lawrence Lee Sowers, Ballston Lake, NY (US)

Correspondence Address: NIXON & VANDERHYE P.C., 901 NORTH GLEBE ROAD, 11TH FLOOR, ARLINGTON, VA, 22203, US

(21) Appl. No.: 10/822,872

(22) Filed: Apr. 13, 2004

(51) Int. Cl. B05D 5/00

(52) U.S. Cl. 427/372.2; 427/421.1

(57) ABSTRACT

A method of coating a stator bar end inserted through an opening within a stator bar end fitting, the fitting having a chamber and the stator bar end having free ends of solid and hollow strands exposed within the chamber, the method including inserting a spray head nozzle through another opening in the fitting and in proximity to the free ends of the solid and hollow strands; spraying an epoxy resin composition so as to form a coating over the free ends of the solid and hollow strands and over at least a portion of adjoining wall surfaces of the fitting within the chamber; and curing the coating.

### BACKGROUND OF THE INVENTION

The present invention relates to a method for creating a uniform epoxy lining on the end surface of liquid-cooling stator bar clip-to-strand braze joints.

Water-cooled stator bars for electrical generators are comprised of a plurality of small rectangular solid and hollow copper strands which are brazed to one another and to an end fitting in which the strands are received. The end fitting serves as both an electrical and a hydraulic connection for the stator bar. The end fitting typically includes an enclosed chamber for ingress or egress of stator bar cooling liquid, typically deionized water. Another opening of the end fitting receives the ends of the strands of the stator bar, with the fitting and peripherally outermost copper strands of the stator bar being brazed to one another. Over time, leaks have developed about the connection between the stator bar ends and the stator bar fitting (or clip) as well as between adjacent strands. It is believed, based on leak analysis results, that the leak mechanism is due to corrosion which initiates in the braze alloy at the interior surface of the braze joint, oftentimes where stagnant water contacts the interface of the braze alloy and the copper strands.

Currently, an epoxy injection technique has been employed as a leak repair method as disclosed, for example, in commonly owned U.S. Pat. No. 5,605,590. The epoxy barrier coating has been injected manually to provide protection against water initiated corrosion mechanisms along the brazed length of the strand package. Based on the experience of this technology, it was incorporated into the manufacturing process for liquid-cooled stator bars. This is a proactive solution intended to extend the life of the product, and to insure the highest reliability of the liquid-cooled generator fleet. When the injection volume was significantly increased, however, it became obvious that this manually implemented technique not only is labor-intensive, but also produces high rates of human related defects. Specific areas of concern in connection with the above process include difficult access, both visual and for injection purposes; uneven coating; creation of voids and pinholes; and visual inspection limitations.

### BRIEF DESCRIPTION OF THE INVENTION

In an exemplary embodiment of this invention, a single or two-part epoxy resin is uniformly sprayed or dispensed over the end surface of the liquid-cooled stator bar clip-to-strand braze joints, as well as on at least part of the inside surfaces of the fitting or clip. The coating may be cured either at room temperature or at an elevated temperature, depending on the specific resin materials used. The spray may also be applied to a preheated surface, producing quick gelling of the resin.

Accordingly, in one aspect, the present invention relates to a method of coating a stator bar end inserted through an opening within a stator bar end fitting, the fitting having a chamber and the stator bar end having free ends of solid and hollow strands exposed within the chamber, the method comprising inserting a spray head nozzle through another opening in the fitting and in proximity to the free ends of the solid and hollow strands; spraying an epoxy resin composition so as to form a coating over the free ends of the solid and hollow strands and over at least a portion of adjoining wall surfaces of the fitting within the chamber; and curing the coating.

In another aspect, the invention relates to a method of coating a stator bar end inserted within a stator bar end fitting, the fitting having a chamber for receiving a liquid through an opening in the fitting, and the stator bar end including solid and hollow strands wherein, in use, the liquid flows through the chamber and through the hollow strands, the method comprising inserting a spray head nozzle through the opening and in proximity to the stator bar end; and spraying an epoxy resin composition so as to form a coating having a thickness of from 2-40 mil over the stator bar end and over at least a portion of adjoining surfaces of the fitting within the chamber and wherein the portion of the adjoining surfaces extends beyond an interface of the stator bar end and interior surfaces of the fitting; and curing the coating.

In still another aspect, the invention relates to a method of coating a stator bar end inserted through an opening within a stator bar end fitting, the fitting having a chamber and the stator bar end having free ends of solid and hollow strands exposed within the chamber, the method comprising inserting a spray head nozzle through another opening in the fitting and in proximity to the free ends of the solid and hollow strands; spraying a hydraphobic epoxy resin composition so as to form a coating over the free ends of the solid and hollow strands and over at least a portion of adjoining wall surfaces of the fitting within the chamber wherein the coating is applied to a thickness of from 2 to 40 mil; and wherein the portion of the adjoining surfaces includes at least ¼ to ½ inch beyond an interface of the stator bar end and interior surfaces of the fitting; and curing the coating.

The invention will now be described in detail in connection with the drawings identified below.

### BRIEF DESCRIPTION OF THE DRAWINGS

FIG. 1 is a schematic illustration of a liquid-cooled stator winding arrangement illustrating the stator bars and end fittings coupled to inlet and outlet coolant headers;

FIG. 2 is a representative end cross-sectional view of the strands of a stator bar within an end fitting;

FIG. 3 is an enlarged cross-sectional view illustrating a viewer and applicator in an opening of the fitting applying epoxy to joint portions between adjacent strands in accordance with a known technique; and

FIG. 4 is a view similar to FIG. 3, but illustrating a method of application of epoxy in accordance with this invention.

### DETAILED DESCRIPTION OF THE INVENTION

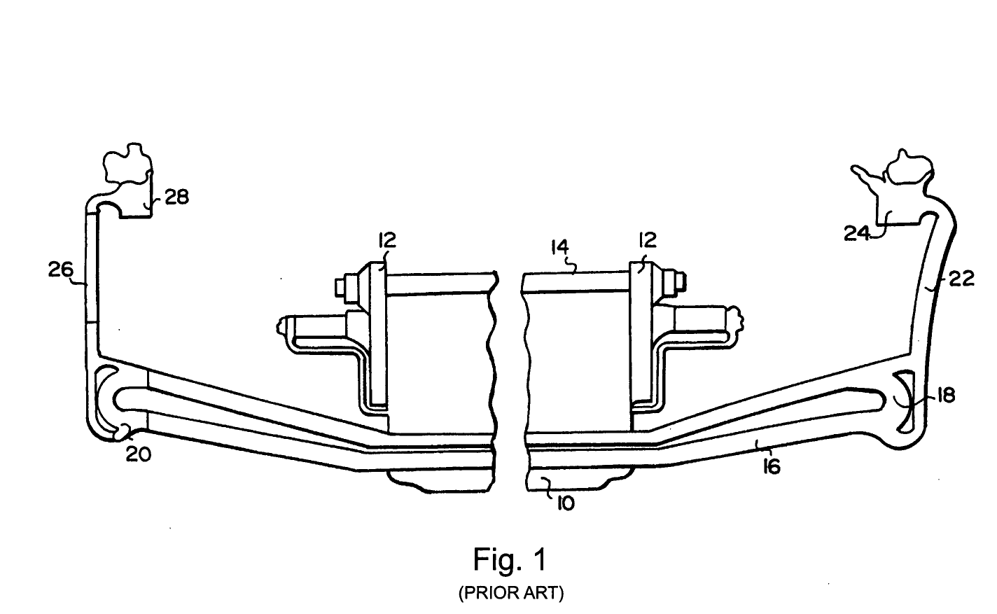

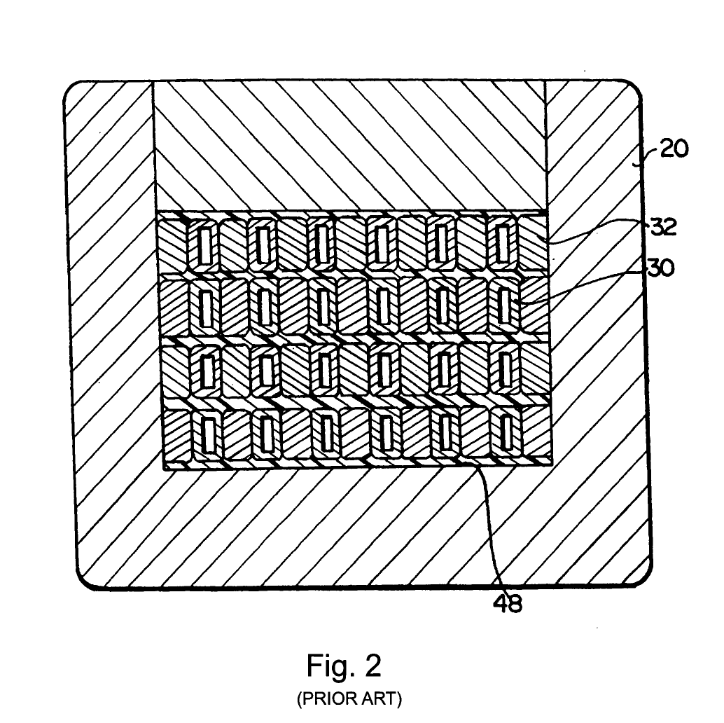

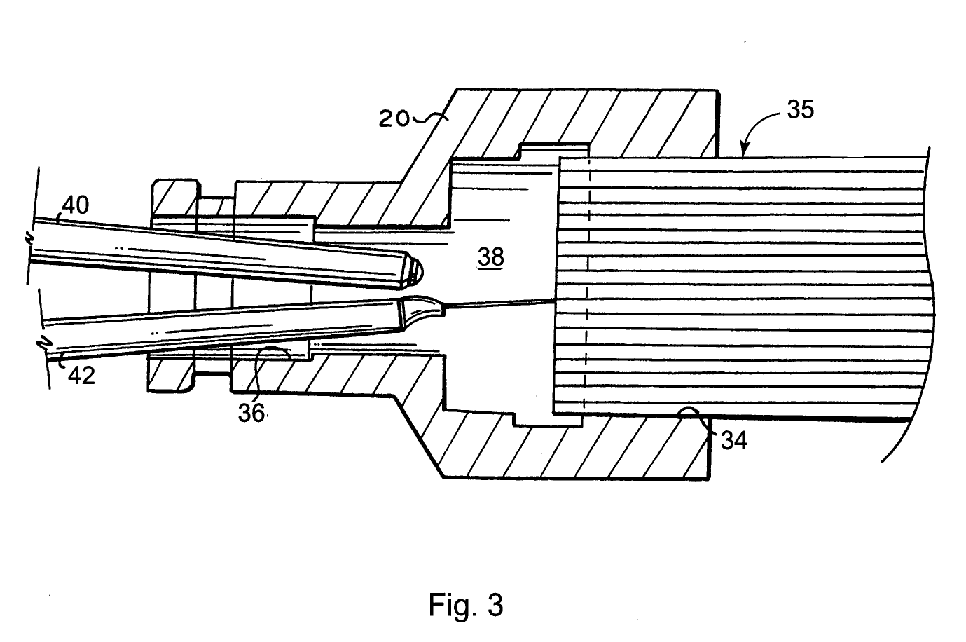

Referring now to the drawings, particularly to FIG. 1, there is illustrated a liquid-cooled stator winding arrangement used in a typical liquid-cooled generator. A typical stator core 10 has stator core flanges 12 and core ribs 14 with stator bars 16 passing through radially extending slots and terminating at opposite ends in end fittings 18 and 20. Inlet hoses 22 connect the inlet fitting or clip 18 to an inlet coolant header 24. Outlet hoses 26 connect the outlet fitting 20 to an outlet coolant header 28. As illustrated in FIG. 2, each stator bar 16 includes a plurality of hollow and solid copper strands 30 and 32, respectively, disposed in side-by-side and superposed relation one to the other. The fittings or clips 18 and 20 are similarly formed of an electrically conductive material such as copper. For purposes of this invention, only one of the fitting or clips needs to be described in detail. As best seen in FIGS. 2 and 3, the fitting 20 comprises a closed body having a first (rectilinear) opening 34 at one end for receiving the stator bar end 35 and, specifically, the free ends of the strands 30, 32. At the opposite end, there is provided a second opening 36 which, in use, is normally closed by a copper tube which serves as both an electrical connection as well as a hydraulic conduit for flowing liquid coolant, e.g., deionized water, into or from a chamber 38. The latter is defined by the interior walls of the hollow fitting 20 and the exposed free ends of the hollow and solid copper strands 30, 32. In use, the liquid in the chamber 38 either flows into the fitting and through the hollow strands for cooling purposes when the fitting comprises an inlet fitting, or flows out of the fitting from the hollow strands when the fitting is employed as an outlet fitting.

According to the prior technique mentioned above, a boroscope 40 is inserted through the opening 36 and the first part of the epoxy, which is of low viscosity, is mixed and manually injected by way of an applicator syringe 42. Specifically, the syringe 42 is inserted through the same opening 36, and while viewing the joints between the fitting and the outermost strands of the stator bars, as well as between the strands themselves, the low viscosity epoxy is injected so as to overlie the brazing alloy, as well as any other exposed portions of the joints. After the low viscosity epoxy has been applied manually over all of the joints, the second part of the epoxy, which is of higher viscosity, is applied in the same manner to the same joints, overlying the low viscosity epoxy. After the application of both the low and high viscosity epoxy material, the epoxy is cured by heating. As noted above, this manual application is labor-intensive and prone to error.

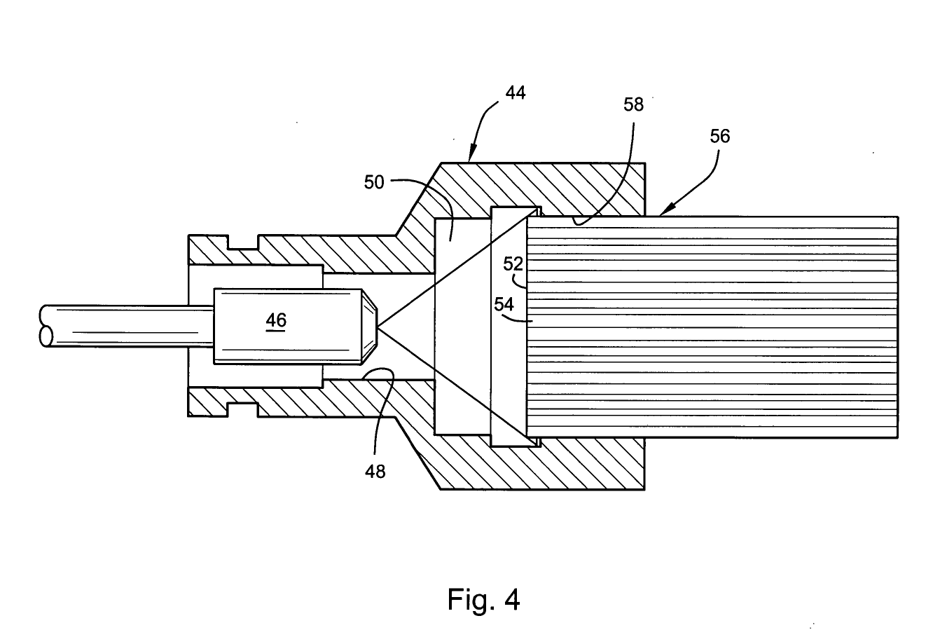

In FIG. 4, a fitting 44 is shown that is similar to the fitting 20 shown in FIG. 3. Here, however, a single epoxy spray nozzle 46 is inserted through the opening 48 and into the chamber 50 and actuated to spray a one or two-part epoxy resin uniformly over the exposed free ends of the solid and hollow strands 52, 54 of the stator bar end 56 received through opening 58. The coating seals the strand-to-strand braze joints as well as the stator bar clip-to-strand braze joints. The spray is also applied to at least part of the inside surfaces of the clip or fitting 44. Because the corrosion is initiated primarily at the interface of the braze material and the copper fitting and copper strands, the epoxy coating or lining should at least cover and seal this interface and therefore it is preferred that the epoxy material extend about ¼ to ½ inch beyond the ends of the strands and onto the interior surfaces of the chamber. In the preferred arrangement, the thickness of the coating or lining will be from 2 to 40 mil (preferably at least 10 mil). The coating may be cured either at room temperature or at elevated temperature, depending on the requirements of the resin materials. The spray may also be applied, however; to a preheated fitting assembly to achieve quick gelling of the coating which is subsequently cured.

In an alternative arrangement, the spray head could be “fished” through the inlet or outlet hoses 22, 26, thus avoiding disassembly and reassembly of the hoses and associated re-brazing of the plumbing connections.

The epoxy may be of any suitable number of available resins, so long as the resin is hydrophobic. Since the stator bar ends are brazed to each other and to the clip, the epoxy resin must also be one that bonds well to both copper and typical brazing alloys.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of coating a stator bar end inserted through an opening within a stator bar end fitting, the fitting having a chamber and the stator bar end having free ends of solid and hollow strands exposed within the chamber, the method comprising:
inserting a spray head nozzle into another opening in the fitting and in proximity to the free ends of the solid and hollow strands;
spraying an epoxy resin composition so as to form a coating over the free ends of the solid and hollow strands and over at least a portion of adjoining wall surfaces of the fitting within the chamber; and
curing the coating.

2. The method of claim 1 wherein the coating is applied to a thickness of from 2 to 40 mil.

3. The method of claim 1 wherein the coating is applied to a thickness of at least 10 mil.

4. The method of claim 1 wherein said portion of said adjoining surfaces includes at least ¼ to ½ inch beyond an interface of the stator bar end and interior surfaces of the fitting.

5. The method of claim 1 wherein said hollow strands remain open during spraying.

6. The method of claim 1 wherein said hollow strands are plugged during spraying.

7. The method of claim 1 wherein the ends of the solid and hollow strands are brazed to each other and to the adjoining wall surfaces of the fitting before spraying the epoxy resin.

8. The method of claim 1 wherein said epoxy resin is hydraphobic.

9. The method of claim 1 wherein said stator bar end and said fitting are pre-heated prior to spraying.

10. The method or claim 1 wherein said coating is cured at room temperature.

11. The method or claim 1 wherein said coating is cured at an elevated temperature.

12. A method of coating a stator bar end inserted within a stator bar end fitting, the fitting having a chamber for receiving a liquid through an opening in the fitting, and the stator bar end including solid and hollow strands wherein, in use, the liquid flows through the chamber and through the hollow strands, the method comprising:
inserting a spray head nozzle through the opening and in proximity to the stator bar end; and
spraying an epoxy resin composition so as to form a coating having a thickness of from 2-40 mil over the stator bar end and over at least a portion of adjoining surfaces of the fitting within the chamber and wherein said portion of said adjoining surfaces extends beyond an interface of the stator bar end and interior surfaces of the fitting; and
curing the coating.

13. The method of claim 12 wherein said hollow strands remain open during spraying.

14. The method of claim 12 wherein said hollow strands are plugged during spraying.

15. The method of claim 12 wherein the ends of the solid and hollow strands are brazed to each other and to the adjoining wall surfaces of the fitting before spraying the epoxy resin.

16. The method of claim 12 wherein said epoxy resin is hydraphobic.

17. The method of claim 12 wherein said stator bar end and said fitting are pre-heated prior to spraying.

18. The method or claim 12 wherein said coating is cured at room temperature.

19. The method of claim 12 wherein said coating is cured at an elevated temperature.

20. The method of claim 12 wherein said coating extends ¼ to ½ inch beyond an interface of the stator bar end and the adjoining surfaces of the fitting.

21. A method of coating a stator bar end inserted through an opening within a stator bar end fitting, the fitting having a chamber and the stator bar end having free ends of solid and hollow strands exposed within the chamber, the method comprising:
inserting a spray head nozzle through another opening in the fitting and in proximity to the free ends of the solid and hollow strands;
spraying a hydrophobic epoxy resin composition so as to form a coating over the free ends of the solid and hollow strands and over at least a portion of adjoining wall surfaces of the fitting within the chamber wherein the coating is applied to a thickness of from 2 to 40 mil; and wherein said portion of said adjoining surfaces includes at least ¼ to ½ inch beyond an interface of the stator bar end and interior surfaces of the fitting; and
curing the coating.
